(19) United States
(12) Patent Application Publication
(10) Pub. No.: US 2009/0117463 A1
(43) Pub. Date: May 7, 2009

(54) LITHIUM ION SECONDARY BATTERY

(76) Inventors: Hideharu Takezawa, Nara (JP); Masato Fujikawa, Osaka (JP); Miyuki Nakai, Osaka (JP)

Correspondence Address: MCDERMOTT WILL & EMERY LLP, 600 13TH STREET, NW, WASHINGTON, DC, 20005-3096, US

(21) Appl. No.: 12/261,381

(22) Filed: Oct. 30, 2008

(30) Foreign Application Priority Data
Nov. 2, 2007 (JP) 2007-286678
Sep. 22, 2008 (JP) 2008-243059

(51) Int. Cl. H01M 4/48; H01M 4/50; H01M 4/52; H01M 4/38

(52) U.S. Cl. 429/220; 429/231.95; 429/231.1; 429/221; 429/224; 429/231.2

(57) ABSTRACT

In a lithium ion secondary battery including a positive electrode, a negative electrode containing an alloy-based negative electrode active material, a separator, a positive electrode lead, a negative electrode lead, a gasket, and an outer case, the positive electrode is allowed to contain an oxygen deficient non-stoichiometric oxide, or an oxygen removing layer containing an oxygen deficient non-stoichiometric oxide is provided between the positive electrode and the separator. In a lithium ion secondary battery containing the alloy-based negative electrode active material, a reaction between oxygen generated in the positive electrode and the alloy-based negative electrode active material, and heat generation accompanying the reaction are prevented.

### FIELD OF THE INVENTION

The present invention relates to lithium ion secondary batteries, and relates particularly to an improvement of a lithium ion secondary battery containing an alloy-based negative electrode active material.

### BACKGROUND OF THE INVENTION

Lithium ion secondary batteries have high capacity and high energy density, and their size and weight reduction can be easily achieved. Therefore, lithium ion secondary batteries are widely used as a power source for portable small electronic devices, including, for example, mobile phones, personal digital assistants (PDAs), notebook personal computers, camcorders, and portable game devices. In a typical lithium ion secondary battery, a positive electrode containing a lithium cobalt compound as the positive electrode active material, a negative electrode containing a carbon material as the negative electrode active material, and a separator made of a porous polyolefin film are used. Such lithium ion secondary batteries have high capacity and high output, as well as long life. However, under current situations where portable small electronic devices are becoming multifunctional and an extension of continuously operable time is demanded, lithium ion secondary batteries are required to have even higher capacity.

For achieving lithium ion secondary batteries of higher capacity, for example, development of a high capacity negative electrode active material is in progress. Alloy-based negative electrode active materials that absorb lithium by forming an alloy with lithium are gaining attention as a high capacity negative electrode active material. Known alloy-based negative electrode active materials include, for example, silicon, tin, oxides of these, nitrides of these, and compounds and alloys containing these. The alloy-based negative electrode active materials have a high discharge capacity. For example, Japanese Laid-Open Patent Publication No. 2002-83594 mentions that silicon has a theoretical discharge capacity of about 4199 mAh/g, which is about eleven times greater than the theoretical discharge capacity of graphite, which has been used as the negative electrode active material.

The alloy-based negative electrode active material is effective in terms of achieving a high capacity lithium ion secondary battery. However, for bringing into practical use of a lithium ion secondary battery containing the alloy-based negative electrode active material, there are several problems to be solved. For example, it is very important to ensure the safety of a lithium ion secondary battery containing an alloy-based negative electrode active material. Because lithium ion secondary batteries are used as a main power source for, i.e., portable small electronic devices, it can be assumed that the lithium ion secondary batteries are used in various environments on the earth. That is, lithium ion secondary batteries are required to operate reliably without occurrence of abnormal heat generation all the time, not only at the time of overdischarge or an internal short circuit, and stably serve the convenience of a user, in various environments from an extreme low temperature environment to a high temperature and humidity environment.

Various proposals have been made so far to improve the safety of lithium ion secondary batteries. There has been proposed, for example, in Japanese Laid-Open Patent Publication No. Hei 11-144734 (in the following, referred to as a “Patent Document”), a lithium ion secondary battery that includes a positive electrode containing a positive electrode active material and a conductive agent carrying an oxygen absorbent that is an oxygen deficient non-stoichiometric oxide (in the following, simply called a “non-stoichiometric oxide”). In the technique of the Patent Document, the conductive agent carrying a non-stoichiometric oxide is used in order to prevent the lithium ion secondary battery from thermal runaway caused by heat generation in reactions between the electrolyte and oxygen generated in the positive electrode at the time of overcharge and abnormal heat generation from, for example, an exposure to fire or sunlight. In other words, by allowing the conductive agent to carry a non-stoichiometric oxide, the non-stoichiometric oxide absorbs oxygen in the positive electrode at the time of, for example, overcharge or abnormal heat generation, inhibiting the oxidation reaction between the oxygen and the electrolyte.

However, because non-stoichiometric oxides are either non-conductive or poorly conductive, when a non-stoichiometric oxide is carried on the conductive agent, conductivity between the positive and negative electrodes and further current collecting ability decline, giving adverse effects on the output performance of the lithium ion secondary battery. In the technique of the Patent Document, it is impossible to prevent the oxidation reaction between the electrolyte and oxygen generated in the positive electrode even if a layer containing a conductive agent carrying the non-stoichiometric oxide is formed on the surface of the positive electrode. Also, as described above, in order to bring out the oxygen-absorbing ability of the non-stoichiometric oxide at the time of overcharge and abnormal heat generation, the non-stoichiometric oxide has to be carried on the conductive agent (paragraph [0020])). Therefore, even if non-stoichiometric oxide powder is merely dispersed as-is in the positive electrode, the oxidation reaction between oxygen and the electrolyte cannot be prevented. Moreover, the lithium ion secondary battery disclosed in the Patent Document uses a carbon material as the negative electrode active material.

### BRIEF SUMMARY OF THE INVENTION

An object of the present invention is to provide a highly safe lithium secondary battery containing an alloy-based negative electrode active material, and having high energy density, high output, and excellent charge and discharge cycle characteristics, without fear of possible heat generation.

The present inventors have diligently conducted research to improve the safety of the lithium ion secondary battery containing an alloy-based negative electrode active material. In the process of the research, they have found that in the lithium ion secondary battery containing the alloy-based negative electrode active material, when oxygen generated in the positive electrode reacts with the alloy-based negative electrode active material, compared with a conventional lithium ion secondary battery using a carbon material as the negative electrode active material, the oxidation becomes intense and causes abrupt heat generation, resulting in a reduction in battery safety. Furthermore, the inventors of the present invention have found that in the lithium ion secondary battery containing an alloy-based negative electrode active material, even if the non-stoichiometric oxide is not carried on the conductive agent, the non-stoichiometric oxide brings out oxygen-absorbing ability, thereby completing the present invention.

That is, the present invention relates to a lithium ion secondary battery including a negative electrode containing an alloy-based negative electrode active material capable of absorbing and desorbing lithium; a positive electrode containing a positive electrode active material capable of absorbing and desorbing lithium; a separator; and a non-aqueous electrolyte;

wherein the positive electrode contains an oxygen deficient non-stoichiometric oxide, or an oxygen removing layer containing an oxygen deficient non-stoichiometric oxide is provided between the positive electrode and the separator.

The alloy-based negative electrode active material preferably contains silicon or tin.

The alloy-based negative electrode active material is more preferably at least one selected from the group consisting of silicon, a silicon oxide, a silicon carbide, a silicon nitride, a silicon-containing alloy, a silicon-containing compound, tin, a tin oxide, a tin nitride, a tin-containing alloy, and a tin-containing compound.

The positive electrode preferably includes a positive electrode active material layer containing a positive electrode active material capable of absorbing and desorbing lithium and an oxygen deficient non-stoichiometric oxide, and a positive electrode current collector.

According to another embodiment of the lithium ion secondary battery, the positive electrode preferably includes a positive electrode active material layer containing a positive electrode active material capable of absorbing and desorbing lithium, and a positive electrode current collector, and an oxygen removing layer containing an oxygen deficient non-stoichiometric oxide is provided so as to be brought into contact with the positive electrode active material layer.

The oxygen deficient non-stoichiometric oxide is preferably an oxygen deficient non-stoichiometric metal oxide of at least one element selected from the group consisting of transition metal elements of the fourth to fifth periods of the periodic table; metal elements of the third period of the periodic table; and metalloid elements of the third to fifth periods of the periodic table.

The oxygen deficient non-stoichiometric oxide is preferably at least one selected from the group consisting of CUO₁₋ₐ, CU₂O₁₋ₐ, Fe₂O₃₋ₐ, Fe₃O₄₋ₐ, FeO₁₋ₐ, SnO_{2-b}, ZnO₁₋ₐ, TiO₂₋ₐ, Ti₂O₃₋ₐ, TiO₁₋ₐ, V₂O_{5-c}, VO₁₋ₐ, VO₂₋ₐ, MoO_{2-b}, MoO₃₋ₐ, MnO₁₋ₐ, MnO_{2-b}, Mn₂O₃₋ₐ, SiO₂₋ₓ, MgO_{1-y}, and Al₂O_{3-z} (where 0<a≦0.8, 0<b≦1.8, 0<c≦2.8, 0<x<2, 0<y<1, and 0<z<3).

Among these, at least one selected from the group consisting of SiO₂₋ₓ, MgO_{1-y}, and Al₂O_{3-z} (where x, y, and z are the same as the above-described) is particularly preferable.

Because a lithium ion secondary battery of the present invention contains the alloy-based negative electrode active material, the energy density and output are high, and further, charge and discharge cycle characteristics are excellent. Moreover, a lithium ion secondary battery of the present invention is highly safe and has no concern all the time over the heat generation accompanying the reaction between the alloy-based negative electrode active material and oxygen, not only at the time of overdischarge and abnormal heat generation. Therefore, a lithium ion secondary battery of the present invention can be suitably used for, for example, a power source of portable small electronic devices that have multiple functions, and the portable small electronic devices can be reliably operated for a longer period of time than with conventional lithium ion secondary batteries.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical cross-sectional view schematically illustrating the configuration of a lithium ion secondary battery according to an embodiment of the present invention.

FIG. 2 is a vertical cross-sectional view schematically illustrating the configuration of a negative electrode according to another embodiment.

FIG. 3 is a perspective view schematically illustrating the configuration of a negative electrode current collector included in the negative electrode shown in FIG. 2.

FIG. 4 is a vertical cross-sectional view schematically illustrating the configuration of a column included in the negative electrode active material layer of the negative electrode shown in FIG. 2.

FIG. 5 is a vertical cross-sectional view schematically illustrating the configuration of a lithium ion secondary battery according to another embodiment of the present invention.

FIG. 6 is a side view schematically illustrating the configuration of an electron beam deposition apparatus.

FIG. 7 is a side view schematically illustrating the configuration of a deposition apparatus according to another embodiment.

### DETAILED DESCRIPTION OF THE INVENTION

A lithium ion secondary battery of the present invention is characterized in that it includes a negative electrode, a positive electrode, a separator, and a non-aqueous electrolyte; the negative electrode contains an alloy-based negative electrode active material capable of absorbing and desorbing lithium; and the positive electrode contains an oxygen deficient non-stoichiometric oxide, or an oxygen removing layer containing an oxygen deficient non-stoichiometric oxide is provided between the positive electrode and the separator.

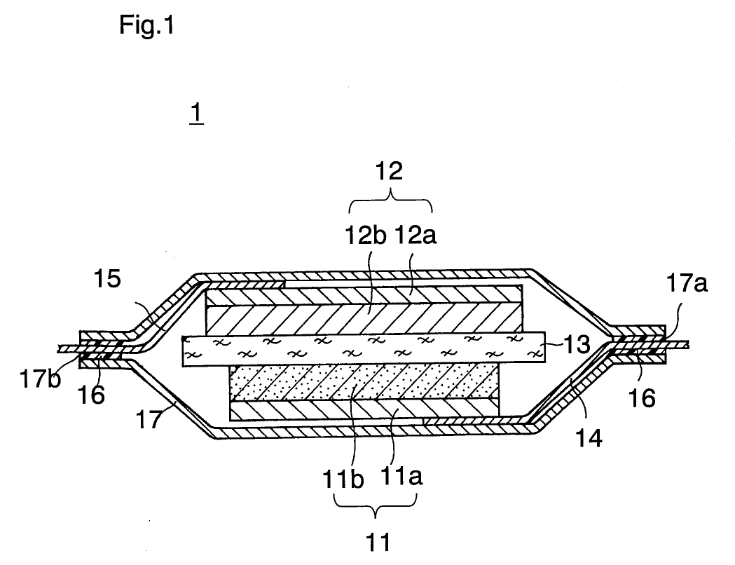

FIG. 1 is a vertical cross-sectional view schematically illustrating the configuration of a lithium ion secondary battery 1 according to an embodiment of the present invention. The lithium ion secondary battery 1 includes a positive electrode 11, a negative electrode 12, a separator 13, a positive electrode lead 14, a negative electrode lead 15, a gasket 16, and an outer case 17. The lithium ion secondary battery 1 is a stack-type battery including an electrode assembly in which the positive electrode 11, the separator 13, and the negative electrode 12 are piled up and stacked.

The positive electrode 11 includes a positive electrode current collector 11a and a positive electrode active material layer 11b. As the positive electrode current collector 11a, those commonly used in the art may be used, including, for example, a porous or non-porous conductive substrate made of a conductive resin or a metal material such as stainless steel, titanium, aluminum, an aluminum alloy and the like. Examples of the porous conductive substrate include a mesh material, a net material, a punched sheet, a lath, a porous material, a foam, and a fibrous compact (such as nonwoven fabric). Examples of the non-porous conductive substrate include foil, a sheet, and a film. The thickness of the porous or non-porous conductive substrate is generally 1 to 500 μm, preferably 1 to 50 μm, more preferably 10 to 40 μm, and particularly preferably 10 to 30 μm, although not limited thereto.

The positive electrode active material layer 11b is provided on one or both sides of the surface of the positive electrode current collector 11a in the thickness direction thereof, and includes a positive electrode active material and an oxygen deficient non-stoichiometric oxide. The positive electrode active material layer 11b may also include, for example, a conductive agent and a binder along with the positive electrode active material and the oxygen deficient non-stoichiometric oxide.

The positive electrode active material is not particularly limited, as long as it is capable of absorbing and desorbing lithium ions. For example, lithium-containing composite metal oxides and olivine-type lithium phosphates may be used preferably. The lithium-containing composite metal oxide is a metal oxide containing lithium and a transition metal, or a metal oxide in which a transition metal in such a metal oxide is partially replaced with a different element. Examples of the different element include Na, Mg, Sc, Y, Mn, Fe, Co, Ni, Cu, Zn, Al, Cr, Pb, Sb, and B. Among these, Mn, Al, Co, Ni, and Mg are preferable. The different elements may be used singly, or two or more different elements may be used in combination.

Specific examples of the lithium-containing composite metal oxide include Li₁CoO₂, Li₁NiO₂, Li₁MnO₂, Li₁CoₘNi₁₋ₘO₂, Li₁CoₘM₁₋ₘOₙ, Li₁Ni₁₋ₘMₘOₙ, Li₁Mn₂O₄, and Li₁Mn₂₋ₘMₘO₄, (where M represents at least one element selected from the group consisting of Na, Mg, Sc, Y, Mn, Fe, Co, Ni, Cu, Zn, Al, Cr, Pb, Sb, and B; and 1=0 to 1.2, m=0 to 0.9, and n=2.0 to 2.3).

The value “1” representing the molar ratio of lithium is a value immediately after the preparation of the positive electrode active material, and increases or decreases due to charge and discharge. Among these, lithium-containing composite metal oxides represented by general formula Li₁CoₘM₁₋ₘOₙ (where M, l, m, and n are as defined above.) are preferable.

The lithium-containing composite metal oxides may be made by a known method. For example, the lithium-containing composite metal oxide can be obtained by preparing a composite metal hydroxide containing a metal other than lithium by coprecipitation using an alkaline agent such as sodium hydroxide, and heat-treating this composite metal hydroxide to obtain a composite metal oxide, adding a lithium compound such as lithium hydroxide to the composite metal oxide, followed by further heat treatment.

Specific examples of the olivine-type lithium phosphate include LiXPO₄ (where X is at least one selected from the group consisting of Co, Ni, Mn, and Fe), and Li₂ MPO₄F (where M is as defined above). The positive electrode active material may be used singly, or two or more positive electrode active materials may be used in combination as necessary.

In this embodiment, the oxygen deficient non-stoichiometric oxide is contained in a powder form in the positive electrode active material layer 11b. The oxygen deficient non-stoichiometric oxide is an oxide of a metal element or a metalloid element, in which the metal element or the metalloid element is not completely oxidized. A “not completely oxidized” state is a state in which oxygen atoms are not bonded in a number corresponding to the ionic valency of the metal element or the metalloid element.

According to the Patent Document, the oxygen-absorbing ability of the oxygen deficient non-stoichiometric oxide is not brought out unless it is carried on the surface of the conductive agent in a lithium ion secondary battery using a carbon material as the negative electrode active material. In contrast, in the lithium ion secondary battery using an alloy-based negative electrode active material, as in the present invention, oxygen generated in the positive electrode 11 can be absorbed to the oxygen deficient non-stoichiometric oxide and the reaction between the alloy-based negative electrode active material and oxygen can be prevented even if the oxygen deficient non-stoichiometric oxide is not carried on the conductive agent. Reasons for achieving these effects are not clear yet.

The oxygen-absorbing ability of the oxygen deficient non-stoichiometric oxide can be evaluated by TGA (thermogravimetric analysis). The temperature of the oxygen deficient non-stoichiometric oxide is increased under an oxygen atmosphere, and an increase in its weight is measured. Or, an appropriate amount of a charged positive electrode active material and the oxygen deficient non-stoichiometric oxide are mixed and the temperature is increased, and the weight change is measured. Generally, with an increase in temperature, a charged positive electrode releases oxygen at a certain temperature, and its weight is reduced. When an oxygen deficient non-stoichiometric oxide is mixed, oxygen released from the positive electrode active material is consumed for the oxidation of the oxygen deficient non-stoichiometric oxide, and therefore the amount of weight reduction changes. The amount of oxygen absorbed by the oxygen deficient non-stoichiometric oxide can be calculated from the amount changed.

A known oxygen deficient non-stoichiometric oxide can be used. Preferably, the oxygen deficient non-stoichiometric oxide is an oxygen deficient non-stoichiometric metal oxide of at least one element selected from the group consisting of transition metal elements in the fourth to fifth periods of the periodic table; metal elements in the third period of the periodic table; and metalloid elements in the third to fifth periods of the periodic table. Preferable examples of the transition metal elements in the fourth to fifth periods of the periodic table include Ti, V, Mn, Fe, Cu, and Mo. Preferable examples of the metal elements in the third period of the periodic table include Mg and Al. Preferable examples of the metalloid elements in the third to fifth periods in the periodic table include Si and Sn. Among these, Mg, Al, and Si are preferable, and Si is more preferable.

Specific examples of the oxygen deficient non-stoichiometric oxide include CuO₁₋ₐ, Cu₂O₁₋ₐ, Fe₂O₃₋ₐ, Fe₃O₄₋ₐ, FeO₁₋ₐ, SnO_{2-b}, ZnO₁₋ₐ, TiO₂₋ₐ, Ti₂O₃₋ₐ, TiO₁₋ₐ, V₂O_{5-c}, VO₁₋ₐ, VO₂₋ₐ, MoO_{2-b}, MoO₃₋ₐ, MnO₁₋ₐ, MnO_{2-b}, Mn₂O₃₋ₐ, SiO₂₋ₓ, MgO_{1-y}, and Al₂O_{3-z} (where 0<a≦0.8, 0<b≦1.8, 0<c≦2.8, 0<x<2, 0<y<1, and 0<z<3).

Among these, in view of oxygen-absorbing ability when not carried on the conductive agent, SiO₂₋ₓ, MgO_{1-y}, and Al₂O_{3-z} (where x, y, and z are the same as the above) are preferable, and SiO₂₋ₓ is more preferable. One of the oxygen deficient non-stoichiometric oxides may be used singly, or two or more of the oxygen deficient non-stoichiometric oxides may be used in combination. SnO_{2-b}, SiO₂₋ₓ or the like can be used as an alloy-based negative electrode active material, but these do not absorb and desorb lithium under the positive electrode potential.

The volume average particle size of the oxygen deficient non-stoichiometric oxide is preferably 0.001 to 10 μm, and more preferably 0.005 to 1 μm, in view of, for example, oxygen-absorbing ability, its long-time durability, and conductivity of the positive electrode active material layer 11b, although the particle size is not limited thereto.

The oxygen deficient non-stoichiometric oxide content in the positive electrode active material layer 11b is preferably 3 to 60 wt %, and more preferably 5 to 40 wt % of the total amount of the positive electrode active material layer 11b, although not limited thereto. When the oxygen deficient non-stoichiometric oxide content is below 3 wt %, its oxygen-absorbing ability is reduced, which may possibly result in an insufficient effect of inhibiting the reaction between the alloy-based negative electrode active material and oxygen. On the other hand, when the oxygen deficient non-stoichiometric oxide content exceeds 60 wt %, conductivity between the positive electrode 11 and the negative electrode 12 is reduced, and the output performance of the lithium ion secondary battery 1 may possibly be reduced.

As the conductive agent, those commonly used in the field of lithium ion secondary batteries may be used, including, for example, graphites such as natural graphite and artificial graphite; carbon blacks such as acetylene black, ketjen black, channel black, furnace black, lamp black, and thermal black; conductive fibers such as carbon fiber and metal fiber; fluorocarbon; powder of a metal such as aluminum; conductive whiskers such as zinc oxide whisker and potassium titanate whisker; conductive metal oxides such as titanium oxide; and organic conductive materials such as phenylene derivatives. One conductive agent may be used singly, or two or more conductive agent may be used in combination as necessary.

As the binder also, those commonly used in the field of lithium ion secondary batteries may be used, including, for example, polyvinylidene fluoride (PVDF), polytetrafluoroethylene, polyethylene, polypropylene, aramid resin, polyamide, polyimide, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyether sulphone, hexafluoropolypropylene, styrene-butadiene rubber, modified acrylic rubber, and carboxymethyl cellulose.

A copolymer containing two or more monomer compounds may also be used as the binder. Examples of the monomer compounds include tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene. One binder may be used singly, or two or more binders may be used in combination as necessary.

The positive electrode active material layer 11b may be formed, for example, by applying a positive electrode material mixture slurry that includes a positive electrode active material and an oxygen deficient non-stoichiometric oxide and that may include, as necessary, a conductive agent, a binder, and the like to the surface of the positive electrode current collector 11a, and drying. The positive electrode material mixture slurry can be prepared by dissolving or dispersing, in an organic solvent, a positive electrode active material and an oxygen deficient non-stoichiometric oxide, and as necessary a conductive agent, a binder, and the like, for example.

As the organic solvent, for example, dimethylformamide, dimethylacetamide, methylformamide, N-methyl-2-pyrrolidone (NMP), dimethylamine, acetone, and cyclohexanone may be used. For the preparation of the positive electrode material mixture slurry, any of the common mixers or dispersers that mix powder and liquid may be used.

When the positive electrode material mixture slurry contains the positive electrode active material, the oxygen deficient non-stoichiometric oxide, the conductive agent and the binder, their amounts can be selected as appropriate. The amount of the positive electrode active material is preferably 80 to 98% by weight of the total amount (hereinafter “the solid contents”) of the positive electrode material, the oxygen deficient non-stoichiometric oxide, the conductive agent and the binder. The amount of the oxygen deficient non-stoichiometric oxide is preferably 2 to 60% by weight of the solid contents. The amount of the conductive agent is preferably 1 to 10% by weight of the solid contents, and the amount of the binder is preferably 1 to 10% by weight of the solid contents. Within these ranges, the amounts of these four components can be freely selected such that the total amount thereof is 100% by weight.

The thickness of the positive electrode active material layer 11b may be appropriately selected according to various conditions, including, for example, designed performance and use of the lithium ion secondary battery 1 to be obtained. For example, when the positive electrode active material layer 11b is provided on both sides of the positive electrode current collector 11a, the total thickness of the positive electrode active material layer 11b is preferably about 50 to 100 μm.

The negative electrode 12 includes a negative electrode current collector 12a and a negative electrode active material layer 12b.

As the negative electrode current collector 12a, those commonly used in the field of lithium ion batteries may be used, including, for example, a porous or non-porous conductive substrate made of a conductive resin or a metal material such as stainless steel, titanium, nickel, aluminum, copper, a copper alloy and the like. Examples of the porous conductive substrate include a mesh material, a net material, a punched sheet, a lath, a porous material, a foam, and a fibrous compact (such as nonwoven fabric). Examples of the non-porous conductive substrate include foil, a sheet, and a film. The thickness of the porous or non-porous conductive substrate is generally 1 to 500 μm, preferably 1 to 50 μm, more preferably 10 to 40 μm, and particularly preferably 10 to 30 μm, although not limited thereto.

The negative electrode active material layer 12b includes an alloy-based negative electrode active material, and formed, as a thin film, on one side or both sides of the current collector 12a in the thickness direction thereof. The negative electrode active material layer 12b may be formed of, for example, an alloy-based negative electrode active material and a minute amount of impurities that are contained inevitably. The negative electrode active material layer 12b may also include, along with the alloy-based negative electrode active material, known negative electrode active material and additive, to the extent that will not impair its characteristics. Furthermore, the negative electrode active material layer 12b is preferably an amorphous or a low crystalline thin film containing an alloy-based negative electrode active material and having a thickness of 3 to 50 μm.

The alloy-based negative electrode active material is a negative electrode active material that absorbs lithium by forming an alloy with lithium during charge, and desorbs lithium during discharge under a negative electrode potential. A known alloy-based negative electrode active material may be used, including, for example, a silicon-containing compound and a tin-containing compound, although it is not particularly limited thereto.

Examples of the silicon-containing compound include silicon, a silicon oxide, a silicon carbide, a silicon nitride, a silicon-containing alloy, a silicon compound, and a solid solution thereof. The silicon oxide includes, for example, a silicon oxide represented by the composition formula: SiO_{α} (0.05<α<1.95). The silicon carbide includes, for example, a silicon carbide represented by the composition formula: SiC_{β} (0<β<1). The silicon nitride includes, for example, a silicon nitride represented by the composition formula: SiN_{γ} (0<γ< 4/3).

The silicon-containing alloy includes, for example, an alloy containing silicon and one or more element selected from the group consisting of Fe, Co, Sb, Bi, Pb, Ni, Cu, Zn, Ge, In, Sn, and Ti. The silicon compound includes, for example, a compound in which silicon contained in silicon, a silicon oxide, a silicon carbide, a silicon nitride, and a silicon-containing alloy is partially replaced with one or more element selected from the group consisting of B, Mg, Ni, Ti, Mo, Co, Ca, Cr, Cu, Fe, Mn, Nb, Ta, V, W, Zn, C, N, and Sn. Among these, silicon, and a silicon oxide are particularly preferable.

The tin-containing compounds include, for example, tin, a tin oxide, a tin nitride, a tin-containing alloy, a tin compound, and a solid solution thereof. As the tin-containing compound, for example, tin; a tin oxide such as SnO_{δ} (0<δ<2) and SnO₂; a tin-containing alloy such as a Ni—Sn alloy, a Mg—Sn alloy, a Fe—Sn alloy, a Cu—Sn alloy, and a Ti—Sn alloy; and a tin compound such as SnSiO₃, Ni₂Sn₄, and Mg₂Sn may be used preferably. Among these, tin and a tin oxide such as SnO_{β} (0<β<2) and SnO₂ are particularly preferable. One silicon-containing compound or tin-containing compound may be used singly, or these may be used in combination.

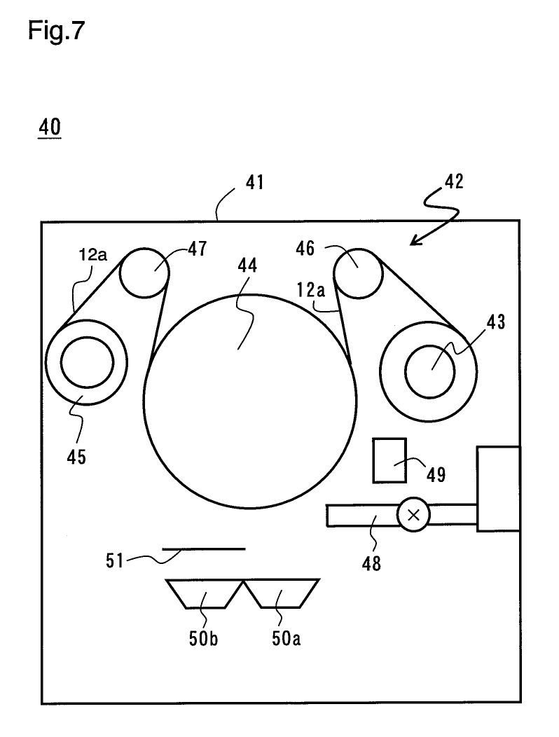

The negative electrode active material layer 12b may be formed, on the surface of the negative electrode current collector 12a according to, for example, a known thin film forming method. The thin film forming method includes, for example, sputtering, a deposition method, a chemical vapor deposition method (CVD) and the like. Among these, the deposition method is preferable. According to the deposition method, for example, the negative electrode active material layer 12b is formed by using a deposition apparatus 40 as shown in FIG. 7. The deposition apparatus 40 will be described in detail in the Example section.

A lithium metal layer may further be formed on the surface of the negative electrode active material layer 12b. At this time, the amount of lithium metal may be the amount corresponding to the irreversible capacity stored in the negative electrode active material layer 12b during first charge and discharge. The lithium metal layer may be formed, for example, by vapor deposition.

The thin film serving as the negative electrode active material layer may be an aggregate of a plurality of columns. The columns contain an alloy-based negative electrode active material, and are formed such that adjacent columns are separated by gaps and are extended outwardly from the surface of the negative electrode current collector. The plurality of columns are preferably formed so as to extend in the same direction. When forming such a thin film of an aggregate of columns, it is preferable that a plurality of projections are provided on the surface of the negative electrode current collector and the columns are formed on the surface of the projections.

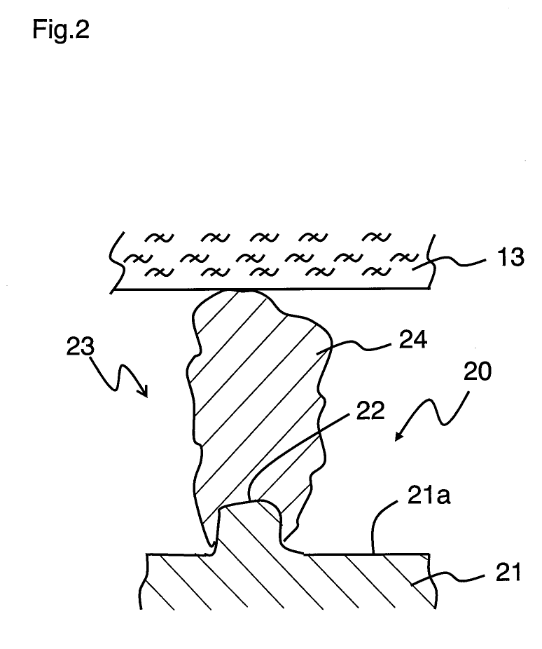

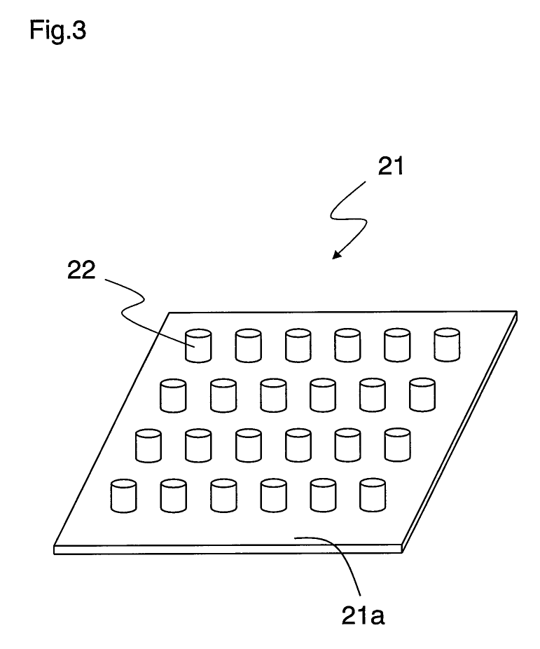

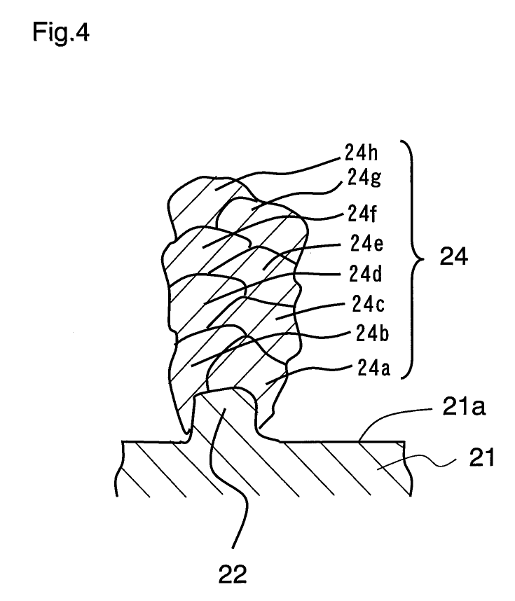

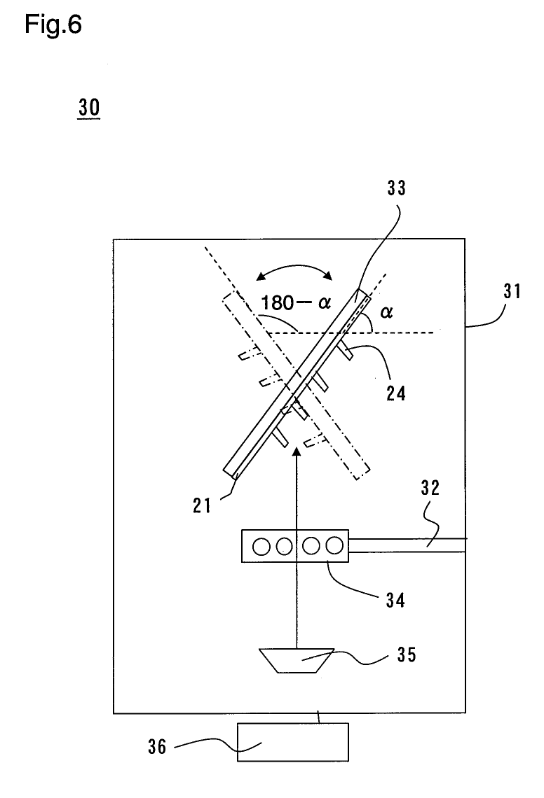

That is, in the present invention, a negative electrode according to another embodiment may be used. The negative electrode includes a negative electrode current collector having a plurality of projections on the surface thereof and a thin film negative electrode active material layer of an aggregate of a plurality of columns. FIG. 2 is a vertical cross-sectional view schematically illustrating the configuration of a negative electrode 20 according to another embodiment. FIG. 3 is a perspective view schematically illustrating the configuration of a negative electrode current collector 21 included in the negative electrode 20 shown in FIG. 2. FIG. 4 is a vertical cross-sectional view schematically illustrating the configuration of a column 24 included in the negative electrode active material layer 23 of the negative electrode 20 shown in FIG. 2. FIG. 6 is a side view schematically illustrating the configuration of an electron beam deposition apparatus 30 for forming the negative electrode active material layer 23.

The negative electrode 20 includes a negative electrode current collector 21 and a thin film negative electrode active material layer 23.

The negative electrode current collector 21 is characterized in that it includes a plurality of projections on one or both surfaces thereof in its thickness direction, as shown in FIG. 3, and other than that, has the same configuration as that of the negative electrode current collector 12a.

The projections 22 are protrusions provided on the surface 21a (in the following, simply called the “surface 21a”) so as to extend outwardly from the surface of the negative electrode current collector 21 in the thickness direction thereof.

Although there is no particular limitation as to the height of the projections 22, their average height is preferably about 3 to 10 μm. In this specification, the height of the projections 22 is determined by the cross section of the projections 22 in the thickness direction of the negative electrode current collector 21. The cross section of the projections 22 is a cross section including the furthest tip in the direction the projections 22 extend. In such a cross section of the projections 22, the height of the projection 22 is the length of a line perpendicular to the surface 21a drawn from the furthest tip in the direction of the extension of the projections 22. The average height of the projections 22 can be determined, for example, by observing the cross section of the negative electrode current collector 21 in the thickness direction thereof with a scanning electron microscope (SEM), measuring the height of, for example, 100 projections 22, and calculating the average of the obtained measurement values

The cross sectional diameter of the projections 22 is, for example, 1 to 50 μm, although not limited thereto. The cross sectional diameter of the projections 22 is a width of the projections 22 in the direction parallel to the surface 21a, in the cross section of the projections 22 of which the height is to be obtained. The cross sectional diameter of the projections 22 can also be determined in the same manner as the height of the projection 22, by measuring 100 projections 22, and calculating the average of the obtained measurement values.

The plurality of projections 22 may not necessarily have the same height or the same cross-sectional diameter.

The shape of the projections 22 is circular in this embodiment. The shape of the projections 22 refers to the shape of the projections 22 viewed from above along the vertical direction when placing the current collector 21 to allow the surface opposite to the surface 21a of the negative electrode current collector 21 to match the horizontal plane. The shape of the projections 22 is not limited to circular, and may be, for example, polygonal, oval, parallelogram, trapezoidal, and rhombic. The polygon preferably is a tri- to octangle, in view of manufacturing costs. An equilateral tri- to octagon are particularly preferable.

The projections 22 have a substantially planar top at the tip in the direction they extend. With the planar top at the tip of the projections 22, the bonding strength between the projections 22 and the columns 24 improves. This tip plane is more preferably substantially parallel to the surface 21a for improving the bonding strength.

The number of the projections 22 and the spaces between the projections 22 are not particularly limited, but appropriately selected according to the size of the projections 22 (height, cross-sectional diameter, and the like) and the size of the columns 24 provided on the surface of the projections 22. For example, the number of the projections 22 is about 10000 to 10000000/cm². The projections are preferably formed such that the distance between the axes of the adjacent projections 22 is about 2 to 100 μm.

Bumps, not shown, may be formed on the surface of the projections 22. With these bumps, for example, the bonding strength between the projections 22 and the columns 24 is further improved, and detachment of the columns 24 from the projections 22, and the spread of the detachment are reliably prevented. The bumps are provided so as to protrude from the surface of the projections 22 outward of the projections 22. A plurality of the bumps having a size smaller than the size of the projections 22 may be formed. The bumps may also be formed at the side face of the projections 22, so as to extend in the circumferential direction and/or in the growth direction of the projections 22. When the projections 22 have the planar top at the tip thereof, one or more bumps smaller than the projections 22 may be formed at the top, and one or more other bumps further extending in one direction may be further formed at the top.

The negative electrode current collector 21 may be made by using a technique, for example, for forming projections and recesses on a metal sheet. Specific examples of such a technique include a method using a roller on which recesses are formed on the surface thereof (in the following, “roller processing”), and the photoresist method.

In the roller processing, a metal sheet is mechanically pressed by using a roller with recesses formed on the surface thereof (in the following, a “projection-forming roller”). With such a roller, metal is caused to plastically deform mainly on the surface of the metal sheet, thereby forming a metal sheet with the projections 22 on at least one of surface thereof serving as the negative electrode current collector 21.

At this time, two projection-forming rollers may be brought into press-contact with each other, so as to allow their axes to be parallel, and a metal sheet may be allowed to pass through the press-contact portion to carry out pressure-molding, thereby obtaining the negative electrode current collector 21 with the projections 22 formed on both surfaces in the thickness direction thereof. Furthermore, a projection-forming roller and a roller with a smooth surface are brought into press-contact with each other so as to allow their axes to be parallel, and a metal sheet is allowed to pass through the press-contact portion to carry out pressure-molding, thereby obtaining a negative electrode current collector 21 with the projections 22 formed on one surface in the thickness direction thereof. The roller with the smooth surface preferably has at least a surface formed of an elastic material. The pressure of the press-contact of the roller is appropriately selected based on various conditions including, for example, the material quality and the thickness of the metal sheet, the shape and the size of the projections 22, and the thickness setting of the negative electrode current collector 21 to be obtained after the pressure molding.

As the metal sheet, for example, a non-porous or porous metal film for use as a common negative electrode current collector may be used. An example of the non-porous metal film may be metal foil. Examples of the porous metal film include a mesh material, a net material, a punched sheet, a lath, a porous material, a foam, and nonwoven fabric. In view of forming the projections 22 by plastic deformation of metal, metal foil is preferably used. Materials of the metal sheet include, for example, stainless steel, nickel, copper, and a copper alloy. The thickness of the metal sheet is generally 1 to 500 μm, preferably 1 to 50 μm, more preferably 10 to 40 μm, and particularly preferably 10 to 30 μm, although not limited thereto.

On the surface of the projection-forming roller in its axial direction, a plurality of recesses is regularly formed. The shape of the internal space of the recesses substantially corresponds to the shape of the projections 22.

The projection-forming roller may be made, for example, by forming, at predetermined positions on the surface of a ceramic roller, apertures serving as the recess portions. For the ceramic roller, for example, those including a core roller and a thermal spray layer are used. For the core roller, for example, a roller made of iron or stainless steel can be used. The thermal spray layer is formed by uniformly thermal-spraying a ceramic material such as a chromium oxide on the surface of the core roller. The recess portions are formed on the thermal spray layer. For forming the recess portions, for example, a laser generally used for mold processing of, for example, a ceramic material can be used.

A projection-forming roller according to another embodiment includes a core roller, a ground layer, and a thermal spray layer. The core roller is the same as the core roller of the ceramic roller. The ground layer is a resin layer formed on the surface of the core roller, and the recesses are formed on the surface of the ground layer. The synthetic resin forming the ground layer preferably has high mechanical strength. The synthetic resin includes, for example, thermosetting resins such as unsaturated polyester, thermosetting polyimide, and epoxy resin; and thermoplastic resins such as fluorocarbon resin, polyamide, polyetherketone, and polyetheretherketone.

For forming the recesses on the ground layer, for example, a resin sheet having recesses on one surface thereof is molded, and bonding the resin sheet to the core roller surface with the face of the resin sheet opposite to the face where the recesses are formed wound around the core roller. The thermal spray layer is formed by thermal-spraying a ceramic material such as chromic oxide on the surface of the ground layer so as to accord with the projections and recesses. Therefore, the recesses formed on the ground layer are preferably formed larger than the designed size of the projections 22 to the degree of the thickness of the thermal spray layer.

The projection-forming roller according to another embodiment includes a core roller and a hard metal layer. The core roller is the same as the core roller of the ceramic roller. The hard metal layer is formed on the surface of the core roller, and includes a hard metal such as tungsten carbide. The hard metal layer can be formed by thermal fitting or cool fitting the hard metal formed into a cylindrical form on the core roller. In the thermal fitting of the hard metal layer, the cylindrical hard metal is warmed to expand, and fitted onto the core roller. In the cool fitting of the hard metal layer, the core roller is cooled to shrink, and inserted into the cylindrical hard metal. On the surface of the hard metal layer, recesses are formed, for example, by laser processing.

In yet another type of projection-forming roll, recesses are formed on the surface of a hard iron-based roller by for example laser processing. The hard iron-based roller is used, for example, for making metal foil by rolling a metal. An example of the hard iron-based roller may be a roller made of high-speed steel, forged steel and the like. The high-speed steel is an iron-based material with metals such as molybdenum, tungsten, and vanadium being added thereto and heat-treated to increase the hardness. The forged steel is an iron-based material made by heating steel ingots or steel slabs that are made by casting a molten steel in a mold, forging with presses and hummers or rolling and forging, and further heat-treating the steel ingots or steel slabs. The steel ingots are made by casting a molten steel in a mold. The steel slabs are made from the steel ingots.

With the photoresist method, a resist pattern is formed on the surface of the metal sheet, and metal plating is further carried out to produce the negative electrode current collector 21.

When bumps are formed on the surface of the projections 22, first, protrusions for the projections having a size larger than the designed size of the projections 22 are formed by the photoresist method. By carrying out etching to the protrusions for the projections, the projections 22 having bumps on the surface thereof are formed. The projections 22 with bumps on the surface thereof can also be formed by plating the surface of the projections 22.

The thin film negative electrode active material layer 23 is formed, for example, as an aggregate of the plurality of columns 24 extending from the surface of the projection 22 to the outside of the negative electrode current collector 21, as shown in FIG. 2. The column 24 extends in the direction perpendicular to the surface 21a of the negative electrode current collector 21 or with a tilt with respect to the perpendicular direction. Because the plurality of columns 24 are separated from each other with gaps between adjacent columns 24, stress due to expansion and contraction at the time of charge and discharge is eased, the negative electrode active material layer 23 is not easily separated from the projections 22, and deformation of the negative electrode current collector 21 and even the negative electrode 20 is barely occurs.

As shown in FIG. 4, the column 24 is more preferably formed as a columnar body formed by stacking eight columnar chunks 24a, 24b, 24c, 24d, 24e, 24f, 24g, and 24h. When forming the column 24, the columnar chunk 24a is formed to cover the top of the projection 22, and then a portion of the side face continued therefrom. Then, the columnar chunk 24b is formed, so as to cover the remaining side face of the projection 22, and a portion of the top face of the columnar chunk 24a.

That is, in FIG. 4, the columnar chunk 24a is formed at one edge of the projection 22 that includes the top face of the projection 22, and a portion of the columnar chunk 24b is stacked on the columnar chunk 24a but the remaining portion is formed at the other edge of the projection 22. Further, the columnar chunk 24c is formed, so as to cover the remaining portion of the top face of the columnar chunk 24a, and a portion of the top face of the columnar chunk 24b. That is, the columnar chunk 24c is formed to contact mainly with the columnar chunk 24a. Further, the columnar chunk 24d is formed to contact mainly with the columnar chunk 24b. By stacking the columnar chunks 24e, 24f, 24g, and 24h alternately in the same manner, the plurality of columns 24 are formed simultaneously, thereby obtaining the thin film negative electrode active material layer 23. Although the eight columnar chunks are stacked in this embodiment, the number of the columnar chunks is not limited thereto, and two or more numbers of the columnar chunks can be stacked.

The plurality of columnar chunks 24 can be formed, for example, by an electron beam deposition apparatus 30 as shown in FIG. 6. In FIG. 6, solid lines are used to illustrate the members in the deposition apparatus 30. The deposition apparatus 30 includes a chamber 31, a first pipe 32, a fixing board 33, a nozzle 34, a target 35, an electron beam generating apparatus (not shown), a power source 36, and a second pipe (not shown).

The chamber 31 is a pressure-tight container having an inner space, and contains the first pipe 32, the fixing board 33, the nozzle 34, and the target 35 therein. One end of the first pipe 32 is connected to the nozzle 34, and the other end extends to the outside of the chamber 31, and is connected to an ingredient gas tank or an ingredient gas producing apparatus (not shown) via a mass flow controller (not shown). Ingredient gas includes, for example, oxygen, nitrogen and the like. The first pipe 32 supplies the ingredient gas to the nozzle 34.

The fixing board 33 is a rotatably supported plate-like member, and the negative electrode current collector 21 can be fixed to one face of the fixing board 33 in the thickness direction thereof. The fixing board 33 is rotated between the position indicated by the solid line and the position indicated by the dash-dotted line in FIG. 6. The position indicated by the solid line is a position at which the surface of the fixing board 33 to which the negative electrode current collector 21 is fixed faces the nozzle 34 located vertically below the board 33 and the angle of the fixing board 33 relative to the line in the horizontal direction is α°. The position indicated by the dash-dotted line is a position at which the surface of the fixing board 33 on which the negative electrode current collector 21 is fixed faces the nozzle 34 located vertically below the board 33 and the angle of the fixing board 33 relative to the line in the horizontal direction is (180−α)°. The angle α° can be appropriately selected based on, for example, the size of the column 24 to be formed.

The nozzle 34 is provided between the fixing board 33 and the target 35 along the vertical direction, and is connected to one end of the first pipe 32. The nozzle 34 allows the vapor of the alloy-based negative electrode active material or an ingredient thereof moving upward in the vertical direction from the target 35 to be mixed with the ingredient gas supplied from the first pipe 32, and supplies the mixture to the surface of the negative electrode current collector 21 fixed onto the surface of the fixing board 33. The target 35 holds the alloy-based negative electrode active material or an ingredient thereof.

The electron beam generating apparatus applies an electron beam to the alloy-based negative electrode active material or the ingredients of the alloy-based negative electrode active material held in the target 35 to heat, thereby generating vapor of these. The power source 36 is provided outside the chamber 31, and electrically connected to the electron beam generating apparatus, to apply a voltage to the electron beam generating apparatus for generating an electron beam. The second pipe introduces gas that forms the atmosphere of the chamber 31. An electron beam deposition apparatus having the same configuration as that of the deposition apparatus 30 is commercially available from, for example, Ulvac Inc.

In the electron beam deposition apparatus 30, first of all, the negative electrode current collector 21 is fixed to the fixing board 33, and oxygen gas is introduced into the chamber 31. In this state, an electron beam is applied to the alloy-based negative electrode active material or the ingredient of the alloy-based negative electrode active material in the target 35 to heat, thereby generating vapor of them. In this embodiment, silicon is used as the alloy-based negative electrode active material. The generated vapor goes up in the vertical direction, and is mixed with ingredient gas upon passing through the nozzle 34, and further goes up to be supplied to the surface of the negative electrode current collector 21 fixed to the fixing board 33, thereby forming a layer including silicon and oxygen on the surface of the projections 22, which are not shown.

At this time, by setting the fixing board 33 to the position indicated by the solid line, the columnar chunk 24a shown in FIG. 4 is formed on the surface of the projection 22. Subsequently, by rotating the fixing board 33 to the position indicated by the dash-dotted line, the columnar chunk 24b shown in FIG. 4 is formed. By rotating in this way the fixing board 33 to reach the positions alternately, the column 24, i.e., the stack of the eight columnar chunks 24a, 24b, 24c, 24d, 24e, 24f, 24g, and 24h shown in FIG. 4, is formed simultaneously, thereby obtaining the negative electrode active material layer 23.

When the negative electrode active material is a silicon oxide represented by, for example, SiOₐ (<a<1.95), the column 24 may be formed so as to provide an oxygen concentration gradient in the thickness direction of the column 24. To be specific, the oxygen content may be made higher in the proximity of the current collector 21, and may be decreased as the distance from the current collector 21 increases. In this way, the bonding strength between the columns 24 and the projections 22 further improves.

When the ingredient gas is not supplied from the nozzle 34, a column 24 mainly composed of silicon or tin simple substance is formed. When, in the electron beam deposition apparatus 30, the negative electrode current collector 12a is used instead of the negative electrode current collector 21 and the fixing board 33 is fixed in a predetermined angle (for example, at the horizontal direction) without being rotated, a thin film of the alloy-based negative electrode active material, that is, the negative electrode active material layer 12b is formed.

By using silicon as the target 35, using oxygen as the ingredient gas to be released from the nozzle 34, and adjusting the amount of oxygen released, a thin film of an alloy-based negative electrode active material or oxygen deficient non-stoichiometric oxide represented by SiOₐ (where “a” is the same as the above-described) can be obtained.

A lithium metal layer may further be formed on the surface of the negative electrode active material layer 23. At this time, the amount of lithium metal may be set to the amount corresponding to the irreversible capacity stored in the negative electrode active material layer 23 at the first time of charge and discharge. The lithium metal layer can be formed, for example, by vapor deposition.

Referring back to FIG. 1, the separator 13 is provided so as to be interposed between the positive electrode 11 and the negative electrode 12. As the separator 13, a sheet or film having predetermined ion permeability, mechanical strength, and nonconductivity is used. Specific examples of the separator 13 include a porous sheet or film such as a microporous film, woven fabric, and nonwoven fabric. The microporous film may be any of a single-layer film and a multi-layer film (composite film). The single-layer film is composed of one type of material. The multi-layer film (composite film) is a stack of the single-layer film composed of one type of material or a stack of the single-layer films composed of different materials.

Although various resin materials may be used for the materials of the separator 13, in view of durability, shutdown function, and battery safety, polyolefins such as polyethylene and polypropylene are preferable. The shutdown function is the function of closing the through holes at the time of battery's abnormal heat generation, thereby inhibiting ion permeation, and shutting down the battery reaction. As necessary, the separator 13 may be formed by two or more stacks of, for example, the microporous film, the woven fabric, or the nonwoven fabric.

The thickness of the separator 13 is generally 10 to 300 μm, preferably, the thickness is 10 to 40 μm, more preferably 10 to 30 μm, and still further preferably 10 to 25 μm. The porosity of the separator 13 is preferably 30 to 70%, and more preferably 35 to 60%. The porosity is the ratio of the total volume of pores present in the separator 13 relative to the volume of the separator 13.

The separator 13 is impregnated with an electrolyte having lithium ion conductivity. The electrolyte having lithium ion conductivity is preferably a non-aqueous electrolyte having lithium ion conductivity. Examples of the non-aqueous electrolyte include a liquid non-aqueous electrolyte, a gelled non-aqueous electrolyte, and a solid electrolyte (for example, polymer solid electrolyte).

The liquid non-aqueous electrolyte contains a solute (supporting salt) and a non-aqueous solvent, and as necessary, further contains various additives. The solute is generally dissolved in the non-aqueous solvent. The separator is impregnated with, for example, a liquid non-aqueous electrolyte.

As the solute, those commonly used in the art may be used, including, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, LiBCl₄, borates, and imide salts.

Examples of the borates include bis(1,2-benzenedioleate (2-)-O,O′) lithium borate, bis(2,3-naphthalenedioleate (2-)-O,O′) lithium borate, bis(2,2′-biphenyldioleate (2-)-O,O′) lithium borate, and bis(5-fluoro-2-olate-1-benzenesulfonic acid-O,O′) lithium borate.

Examples of the imide salts include bis(trifluoromethane sulfonyl) imide lithium ((CF₃SO₂)₂NLi), (trifluoromethane sulfonyl)(nonafluorobutane sulfonyl)imide lithium ((CF₃SO₂)(C₄F₉SO₂)NLi), and bis(pentafluoroethanesulfonyl)imide lithium ((C₂F₅SO₂)₂NLi). One of the solutes may be used singly, or as necessary, two or more of the solutes may be used in combination. The amount of solute to be dissolved in the non-aqueous solvent is preferably in the range of 0.5 to 2 mol/L.

As the non-aqueous solvent, those commonly used in the art may be used, including, for example, cyclic carbonates, chain carbonates, and cyclic carboxylates. Examples of the cyclic carbonates include propylene carbonate (PC), ethylene carbonate (EC) and the like. Examples of the chain carbonates include diethyl carbonate (DEC), ethyl methyl carbonate (EMC), dimethyl carbonate (DMC) and the like. Examples of the cyclic carboxylates include γ-butyrolactone (GBL), γ-valerolactone (GVL) and the like. One of the non-aqueous solvents may be used singly, or as necessary, two or more of them may be used in combination.

Examples of the additives include a material that improves charge and discharge efficiency and a material that makes a battery inactive. The material that improves charge and discharge efficiency improves the charge and discharge efficiency by, for example, decomposing on the negative electrode to form a coating with high lithium ion conductivity. Specific examples of such materials include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), divinyl ethylene carbonate and the like. These may be used singly, or may be used in combination of two or more. Among these, at least one selected from the group consisting of vinylene carbonate, vinyl ethylene carbonate, and divinyl ethylene carbonate is preferable. In the above-described compounds, the hydrogen atoms may be partially replaced with fluorine atoms.

The material that makes a battery inactive makes a battery inactive by, for example, decomposing at the time of battery overcharge, to form a coating on the surface of the electrode. Examples of such materials include benzene derivatives. The benzene derivative includes a benzene compound containing a phenyl group and a cyclic compound group adjacent to the phenyl group. For the cyclic compound group, for example, a phenyl group, a cyclic ether group, a cyclic ester group, a cycloalkyl group, and a phenoxy group are preferable. Specific examples of the benzene derivatives include cyclohexyl benzene, biphenyl, diphenylether, and the like. The benzene derivatives may be used singly, or may be used in combination of two or more. However, the benzene derivative content in the liquid non-aqueous electrolyte is preferably 10 parts by volume or less relative to 100 parts by volume of the non-aqueous solvent.

The gelled non-aqueous electrolyte includes a liquid non-aqueous electrolyte and a polymer material for holding the liquid non-aqueous electrolyte. Here, the polymer material used is a material that is capable of gelling a liquid. As the polymer material, those commonly used in the art may be used including, for example, polyvinylidene fluoride, polyacrylonitrile, polyethylene oxide, polyvinyl chloride, polyacrylate, and the like

The solid electrolyte includes, for example, a solute (supporting salt) and a polymer material. As the solute, those previously described as examples may be used. Examples of the polymer material include polyethylene oxide (PEO), polypropylene oxide (PPO), and a copolymer of ethylene oxide, propylene oxide and the like.

One end of the positive electrode lead 14 is connected to the positive electrode current collector 11a, and the other end of the positive electrode lead 14 is drawn out from an opening 17a of the outer case 17 to the outside of the lithium ion secondary battery 1. One end of the negative electrode lead 15 is connected to the negative electrode current collector 12a, and the other end of the negative electrode lead 15 is drawn out from the opening 17b of the outer case 17 to the outside of the lithium ion secondary battery 1. As the positive electrode lead 14 and the negative electrode lead 15, those commonly used in the technical field of lithium ion secondary batteries are used. The openings 17a and 17b of the outer case 17 are sealed by the gasket 16. As the gasket 16, for example, various resin materials may be used. As the outer case 17 as well, any of those used in the technical field of lithium ion secondary batteries can be used. The openings 17a and 17b of the outer case 17 may be sealed directly by, for example, welding without using the gasket 16.

The lithium ion secondary battery 1 can be made, for example, as follows. First, one end of the positive electrode lead 14 is connected to the positive electrode current collector 11a of the positive electrode 11, at the face opposite to the face where the positive electrode active material layer 11b is formed. Similarly, one end of the negative electrode lead 15 is connected to the negative electrode current collector 12a of the negative electrode 12, at the face opposite to the face where the negative electrode active material layer 23 is formed. Then, the positive electrode 11 and the negative electrode 12 are stacked with the separator 13 interposed therebetween, thereby producing an electrode assembly. At this time, the positive electrode 11 and the negative electrode 12 are disposed such that the positive electrode active material layer 11a and the negative electrode active material layer 12a face each other.

This electrode assembly is inserted in the outer case 17 along with the electrolyte, and the other ends of the positive electrode lead 14 and the negative electrode lead 15 are brought out of the outer case 17. In this state, the openings 17a and 17b are welded with the gaskets 16 interposed therebetween while decreasing the pressure in the outer case under vacuum, thereby obtaining the lithium ion secondary battery 1.

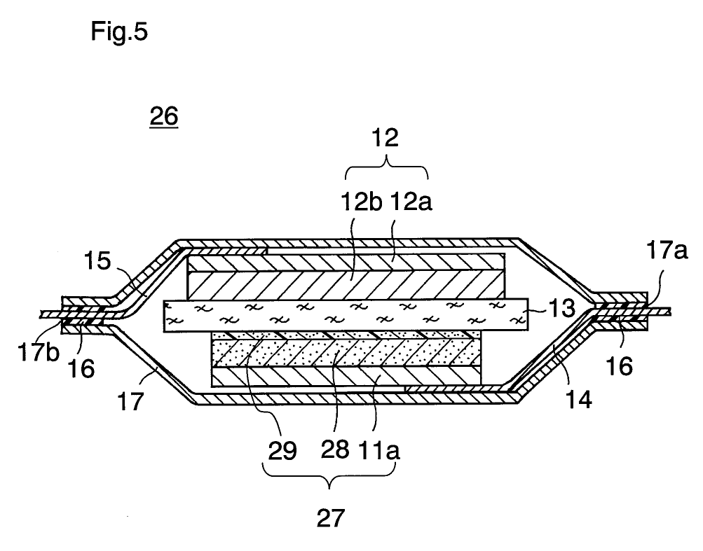

FIG. 5 is a vertical cross sectional view schematically illustrating the configuration of a lithium ion secondary battery 26 according to another embodiment of the present invention. The lithium ion secondary battery 26 is similar to the lithium ion secondary battery 1 shown in FIG. 1, and the same reference numerals are given to the corresponding components and the descriptions thereof are omitted.

The lithium ion secondary battery 26 includes a positive electrode 27, a negative electrode 12, a separator 13, a positive electrode lead 14, a negative electrode lead 15, a gasket 16, and an outer case 17. That is, the lithium ion secondary battery 26 has the same configuration as that of the lithium ion secondary battery 1, except that the positive electrode 27 is included instead of the positive electrode 11.

The positive electrode 27 includes a positive electrode current collector 11a, a positive electrode active material layer 28 and an oxygen removing layer 29. The positive electrode current collector 11a has the same configuration as that of the positive electrode current collector 11a in the lithium ion secondary battery 1. The positive electrode active material layer 28 also has the same configuration as that of the positive electrode active material layer 11b of the lithium ion secondary battery 1, or, except that the oxygen deficient non-stoichiometric oxide is not contained, the positive electrode active material layer 28 has the same configuration as that of the positive electrode active material layer 11b in the lithium ion secondary battery 1.

The oxygen removing layer 29 is provided such that the oxygen removing layer 29 faces the positive electrode active material layer 28. To be specific, the oxygen removing layer 29 is provided, for example, so as to contact the surface of the positive electrode active material layer 28, at a position between the positive electrode active material layer 28 and the separator 13. The reaction between oxygen generated in the positive electrode 27 and the electrolyte cannot be prevented according to conventional techniques when the oxygen removing layer 29 is positioned in such a fashion. However, in a lithium ion secondary battery containing an alloy-based negative electrode active material, as in the present invention, the reaction between the alloy-based negative electrode active material and oxygen more easily occurs than the reaction between the electrolyte and oxygen.

Therefore, by providing the oxygen removing layer 29 between the positive electrode active material layer 28 and the separator 13, oxygen generated in the positive electrode 27 is absorbed by the oxygen removing layer 29, and does not reach the negative electrode 12 containing the alloy-based negative electrode active material. Thus, in the present invention, the reaction between the alloy-based negative electrode active material and oxygen is prevented, and heat generation that accompanies the reaction does not occur.

The oxygen removing layer 29 contains the oxygen deficient non-stoichiometric oxide, and may further contain, as necessary, an inorganic oxide, a conductive agent, and a binder resin. The oxygen deficient non-stoichiometric oxide same as the one contained in the positive electrode active material layer 11b of the lithium ion secondary battery 1 may be used. SiO₂₋ₓ, MgO_{1-y}, and Al₂O_{3-z} (where x, y, and z are the same as the above-described.) are preferable, and SiO₂₋ₓ is further preferable. One oxygen deficient non-stoichiometric oxide may be used singly, or two or more oxygen deficient non-stoichiometric oxides may be used in combination. The particle size of the oxygen deficient non-stoichiometric oxide is also the same as the case when it is included in the positive electrode active material layer 11b of the lithium ion secondary battery 1. The inorganic oxide includes, for example, silica (SiO₂), calcia (CaO), magnesia (MgO), and alumina (Al₂O₃). The inorganic oxide may be used singly, or two or more inorganic oxides may be used in combination.

When using the oxygen deficient non-stoichiometric oxide along with the inorganic oxide, even if the amount of the oxygen deficient non-stoichiometric oxide is decreased, a highly safe battery as proven in a nail penetration test can be obtained. However, the amount of the oxygen deficient non-stoichiometric oxide is preferably 50 wt % or more relative to the total. In this case, the oxygen deficient non-stoichiometric oxide, the inorganic oxide, and a small amount of binder resin are preferably contained. In a specific example, 50 to 98 wt % of the oxygen deficient non-stoichiometric oxide, 1 to 40 wt % of the inorganic oxide, and 1 to 10 wt % of the binder relative to a total are used.

As the binder resin and the conductive agent, those contained in the positive electrode active material layer 11b of the lithium ion secondary battery 1 can be used. Preferable binder resins include, for example, polytetrafluoroethylene, polyvinylidene fluoride (PVDF), and microparticles having rubber-like characteristics. The binder resin and the conductive agent may be used singly, or two or more binder resins and conductive agents can be used in combination.

The thickness of the oxygen removing layer 29 is preferably 1 to 30 μm, and more preferably 2 to 10 μm in view of, for example, long-time durability of oxygen-absorbing ability, lithium ion permeability, and conductivity between the positive electrode 27 and the negative electrode 12, although not limited thereto. When the thickness of the oxygen removing layer 29 is below 1 μm, the effects of the oxygen removing layer 29 may possibly be insufficient. On the other hand, when the thickness of the oxygen removing layer 29 exceeds 30 μm, ion conductivity between the positive electrode 27 and the negative electrode 12 may possibly be insufficient, and may possibly give adverse effects on battery performance such as output performance and charge and discharge cycle characteristics.

The oxygen removing layer 29 may be formed, for example, by applying an ingredient slurry of the oxygen removing layer 29 onto the surface of the positive electrode active material layer 28, and then drying. The ingredient slurry can be prepared, for example, by dispersing or dissolving an oxygen deficient non-stoichiometric oxide, and as necessary a binder resin, a conductive agent, and the like in an organic solvent or water. There is no particular limitation on the organic solvent, as long as it does not give adverse effects on battery performance or the configuration of the positive electrode active material layer 28, and it can dissolve or disperse the binder resin, the conductive agent, and the like. Among these, those that can be used in the preparation of the positive electrode material mixture slurry for the lithium ion secondary battery 1 are preferably used.

The oxygen removing layer 29 can also be formed by fusion bonding or press bonding a resin sheet containing an oxygen deficient non-stoichiometric oxide to the positive electrode active material layer 28 under heat, under pressure, or under heat and pressure. The resin sheet can be formed by applying the above-described ingredient slurry onto the surface of a planar base material such as a glass plate, drying, and as necessary, cutting into a predetermined size.

Although the specific examples illustrated in FIG. 1 and FIG. 5 of the lithium ion secondary batteries 1 and 26 are stack-type electrode assemblies, the battery type is not limited thereto, and the battery can be assembled into a form of a wound-type battery, having a wound-type electrode assembly in which the positive electrode and the negative electrode are wounded with the separator interposed therebetween placed in an outer case or a battery can. That is, the lithium ion secondary battery of the present invention may be in various forms including, for example, a flat battery including a stack-type electrode assembly, a cylindrical battery including a wound-type electrode assembly, and a prismatic battery including a wound-type electrode assembly.

The lithium ion secondary battery of the present invention can be used similarly to conventional lithium ion secondary batteries, particularly, as a power source for portable electronic devices such as personal computers, mobile phones, mobile devices, personal digital assistants (PDAs), mobile game consoles, camcorders, and the like. Expected application also includes a secondary battery assisting an electric motor in hybrid electric vehicles and fuel cell cars; a power source for driving, for example, electrically-powered tools, vacuum cleaners, and robots; and a power source for plug-in HEVs.

### EXAMPLES

The present invention is described in detail in the following Examples, Comparative Examples, and Experimental Examples.

### Example 1

### (1) Positive Electrode Active Material Preparation

Sulfate of cobalt was added to an aqueous solution of NiSO₄ such that Ni:Co=8.5:1.5 (molar ratio) was satisfied, thereby preparing an aqueous solution having a metal ion concentration of 2 mol/L. To this aqueous solution, a 2 mol/L sodium hydroxide solution was dripped gradually while stirring to neutralize, thereby producing by coprecipitation a ternary precipitate having a composition represented by Ni_{0.85}CO_{0.15}(OH)₂. This precipitate was separated by filtration, washed with water, and dried at 80° C., thereby obtaining a composite hydroxide.

This composite hydroxide was heated in air at 900° C. for 10 hours, thereby obtaining a composite oxide having a composition represented by Ni_{0.85}Cu_{0.15}O. At this time, lithium hydroxide monohydrate was added so as to equalize the total number of Ni and Co atoms, and the number of Li atoms, and heated in air at 800° C. for 10 hours, thereby obtaining a lithium-nickel-containing composite metal oxide having a composition represented by LiNi_{0.85}CO_{0.15}O₂. Thus, a positive electrode active material including secondary particles having an average particle size of 10 μm was obtained.

### (2) Positive Electrode Preparation

A positive electrode material mixture paste was prepared by sufficiently mixing 93 g of the obtained positive electrode active material powder, 3 g of acetylene black (conductive agent), 4 g of polyvinylidene fluoride powder (binder), and 50 ml of N-methyl-2-pyrrolidone (NMP). This positive electrode material mixture paste was applied to both sides of aluminum foil (positive electrode current collector) with a thickness of 15 μm, dried, and rolled, thereby forming a positive electrode active material layer with a thickness of 130 μm.

### (3) Oxygen Removing Layer Preparation

A slurry for an oxygen removing layer was prepared by dispersing or dissolving 95 g of SiO_{0.5} powder (volume average particle size 3 μm) and 5 g of polytetrafluoroethylene in 50 ml of pure water. This slurry was applied onto the surface of the positive electrode active material layer, and dried, to form an oxygen removing layer with a thickness of 8 μm, thereby producing a positive electrode of the present invention. Afterwards, the positive electrode was cut into a size of 30 mm×180 mm, thereby making a positive electrode plate.

### (4) Negative Electrode Preparation

FIG. 7 is a side view schematically illustrating the configuration of a deposition apparatus 40 for forming a thin film negative electrode active material layer. The deposition apparatus 40 includes a vacuum chamber 41, a current collector conveyer 42, an ingredient gas supplier 48, a plasma generating means 49, silicon targets 50a and 50b, a shielding plate 51, and an electron beam heating means, which is not shown. The vacuum chamber 41 is a pressure-tight container having an inner space in which the pressure can be decreased, and accommodates the current collector conveyer 42, the ingredient gas supplier 48, the plasma generating means 49, the silicon targets 50a and 50b, the shielding plate 51, and the electron beam heating means in its inner space.

The current collector conveyer 42 includes a feed roller 43, a can 44, a pickup roller 45, and conveyer rollers 46 and 47. The feed roller 43, the can 44, and the conveyer rollers 46 and 47 are provided so as to be rotatable around their axes. A long negative electrode current collector 12a is wound around the feed roller 43. The can 44 has a larger diameter than other rollers, and has a cooler therein, which is not shown. When the negative electrode current collector 12a is conveyed on the surface of the can 44, the negative electrode current collector 12a is cooled. In this way, vapor of the alloy-based negative electrode active material is cooled and precipitated, thereby forming a thin film.

The pickup roller 45 is provided so as to be rotatable around the axis by a driving means, which is not shown. One end of the negative electrode current collector 12a is fixed onto the pickup roller 45, and by the rotation of the pickup roller 45, the negative electrode current collector 12a is conveyed from the feed roller 43 via the conveyer roller 46, the can 44, and the conveyer roller 47. Then, the negative electrode current collector 12a with a thin film of the alloy-based negative electrode active material formed thereon is wound by the pickup roller 45.

The ingredient gas supplier 48 supplies an ingredient gas of, for example, oxygen and nitrogen to the vacuum chamber 41 when a thin film mainly composed of an oxide, a nitride, or the like of silicon or tin is to be formed. The plasma generating means 49 allows the ingredient gas supplied from the ingredient gas supplier 48 to form a plasma. The silicon targets 50a and 50b are used when forming a silicon-containing thin film. The shielding plate 51 is provided so as to be movable in a horizontal direction at vertically below the can 43, and at vertically above the silicon targets 50a and 50b. The position in the horizontal direction of the shielding plate 51 is appropriately adjusted depending upon the forming status of the thin film at the surface of the negative electrode current collector 12a. The electron beam heating means applies an electron beam to the silicon targets 50a and 50b to heat, thereby generating vapor of silicon.

By using the vapor deposition apparatus 40, a thin film negative electrode active material layer (here, silicon thin film) with a thickness of 5 μm was formed on the surface of the negative electrode current collector 12a under the following conditions.

Pressure in Vacuum Chamber 41: 8.0×10⁻⁵ Torr

Negative Electrode Current Collector 12a: electrolytic copper foil with a length of 50 m, a width of 10 cm, and a thickness of 35 μm (manufactured by FURUKAWA CIRCUIT FOIL Co., Ltd.)

Speed of Winding Negative Electrode Current

Collector 12a by Pickup Roller 45 (speed of conveying negative electrode current collector 12a): 2 cm/min.

Ingredient Gas: Not supplied.

Targets 50a and 50b: single crystal silicon having a purity of 99.9999% (manufactured by Shin-Etsu Chemical Co., Ltd.)

Accelerating Voltage of Electron Beam: −8 kV

Electron Beam Emission: 300 mA

The obtained negative electrode was cut to give a size of 35 mm×185 mm, thereby making a negative electrode plate. In this negative electrode plate, lithium metal was allowed to deposition the surface of the thin film negative electrode active material layer (silicon thin film). By depositing lithium metal, lithium was supplemented in the amount corresponding to the irreversible capacity stored in the thin film negative electrode active material layer during initial charge and discharge. Lithium metal was deposited under an argon atmosphere, by using a resistance heating deposition apparatus (manufactured by ULVAC, Inc.). Lithium metal was placed in a boat made of tantalum in the resistance heating deposition apparatus, and the negative electrode plate was fixed such that the negative electrode active material layer faced the boat. Then, the deposition was carried out for 10 minutes by passing a current of 50 A through the boat in the argon atmosphere. Thus, the negative electrode plate for use in the present invention was obtained.

### (5) Stack-Type Battery Fabrication

An electrode assembly was made by stacking the positive electrode plate at the center, and a polyethylene microporous film (separator, product name: Hipore, thickness 20 μm, manufactured by Asahi Kasei Corporation) and the negative electrode plate on both sides of the positive electrode plate such that the positive electrode active material layer and the thin film negative electrode active material layer faced each other with the polyethylene microporous film interposed therebetween. The electrode assembly was inserted into an outer case composed of aluminum laminate sheet along with an electrolyte. For the electrolyte, a non-aqueous electrolyte in which LiPF₆ was dissolved in a mixed solvent of a 1:1 volume ratio of ethylene carbonate (EC) and ethyl methyl carbonate (EMC) at a concentration of 1.0 mol/L was used. Then, a positive electrode lead and a negative electrode lead were brought out from the openings of the outer case to the outside of the outer case, and while reducing the pressure in the outer case under vacuum, the openings of the outer case were welded, thereby making a lithium ion secondary battery of the present invention.

### Example 2

A lithium ion secondary battery of the present invention was made in the same manner as Example 1, except that the production method of the positive electrode was changed as follows, and the oxygen removing layer was not formed.

### [Positive Electrode Preparation]

A positive electrode material mixture paste was prepared by sufficiently mixing 93 g of a positive electrode active material (LiNi_{0.85}CO_{0.15}O₂) powder prepared in the same manner as Example 1, 3 g of acetylene black (conductive agent), 4 g of polyvinylidene fluoride powder (binder), 5 g of SiO_{0.5} powder (oxygen deficient non-stoichiometric oxide, volume average particle size 3 μm), and 50 ml of N-methyl-2-pyrrolidone (NMP). This positive electrode material mixture paste was applied to both sides of aluminum foil (positive electrode current collector) with a thickness of 15 μm, dried, and rolled to form a positive electrode active material layer with a thickness of 135 μm.

### Example 3

A lithium ion secondary battery of the present invention was made in the same manner as Example 1, except that the production method of the negative electrode was changed as follows.

### [Negative Electrode Preparation]

A ceramic layer with a thickness of 100 μm was formed by thermal spraying a chromic oxide on the surface of an iron-made roller with a diameter of 50 mm. A projection-forming roller was made by forming holes, i.e., circular recesses, with a diameter of 12 μm and a depth of 8 μm, on the surface of this ceramic layer by laser processing. Closest packing arrangement of these holes were carried out, with a distance between the axes of adjacent holes of 20 μm. The bottom of these holes was substantially planar at its center, and a portion connecting the periphery of the bottom with the side face is formed so as to be rounded off.

Alloy copper foil (product name: HCL-02Z, thickness 20 μm, manufactured by Hitachi Cable) containing 0.03 wt % zirconia relative to the total amount was heated in an argon gas atmosphere at 600° C. for 30 minutes for annealing. This alloy copper foil was allowed to pass through a press-contact portion where the two projection-forming rolls were brought into press-contact with each other while applying a line pressure of 2 t/cm to pressure-mold the both sides of the alloy copper foil, thereby making a negative electrode current collector for use in the present invention. As a result of observing the cross section of the obtained negative electrode current collector in the thickness direction thereof with a scanning electron microscope, it was found that a plurality of projections was formed on the surface of the negative electrode current collector. The average height of the projections was about 8 μm.

The negative electrode active material layer with projections formed on the negative electrode current collector surface was made by using a commercially available deposition apparatus (manufactured by ULVAC, Inc.) having the same structure as that of the electron beam vapor deposition apparatus 30 shown in FIG. 6. Conditions for the deposition are as follows. The fixing board to which the negative electrode current collector with a size of 35 mm×185 mm was fixed was configured such that the fixing board was angularly displaced between the position at an angle of 60° (α=60°, position shown by solid line in FIG. 6) and the position at an angle of (180−α)=120° (dash-dotted line shown in FIG. 6) in an alternating manner with respect to the straight line in the horizontal direction. In this way, a plurality of columns in which the columnar chunks were stacked in eight layers as shown in FIG. 4 was formed. These columns were grown in the direction where the projection extends, from the top and the side face in the proximity of the top of the projection.

Negative Electrode Active Material Ingredient (Evaporation Source): silicon, purity of 99.9999%, manufactured by Kojundo Chemical Laboratory Co., Ltd.

Oxygen Released from Nozzle: purity of 99.7%, manufactured by Nippon Sanso Corporation.

Flow Rate of Oxygen Released from Nozzle: 80 sccm

Angle α: 60°

Accelerating Voltage of Electron Beam: −8 kV

Emission: 500 mA

Deposition Period: 3 minutes

Thickness T of the negative electrode active material layer formed was 16 μm. The thickness of the negative electrode active material layer was determined by observing the cross section of the negative electrode in the thickness direction thereof with a scanning electron microscope, obtaining the length from the peak of the negative electrode active material layer to the peak of the projection for ten columns of the negative electrode active material layer formed on the projection surface, and calculating the average of the obtained ten measured values. Also, as a result of determining the amount of oxygen contained in the negative electrode active material layer by the combustion method, it was revealed that the composition of the compound forming the negative electrode active material layer was SiO_{0.5}.

Then, lithium metal was deposited on the surface of the negative electrode active material layer. By depositing lithium metal, lithium was supplemented in the amount corresponding to the irreversible capacity stored in the negative electrode active material layer during initial charge and discharge. Lithium metal was deposited under an argon atmosphere, by using a resistance heating deposition apparatus (manufactured by ULVAC, Inc.). Lithium metal was placed in a tantalum boat in the resistance heating deposition apparatus, and the negative electrode was fixed such that the negative electrode active material layer faced the tantalum boat. Then, the deposition was carried out for 10 minutes by passing a current of 50 A through the tantalum boat in the argon atmosphere.

### Example 4

A lithium ion secondary battery of the present invention was made in the same manner as Example 2, except that a negative electrode was made in the same manner as Example 3.

### Example 5

A slurry for an oxygen removing layer was prepared by dispersing or dissolving 50 g of Al₂O₃ powder, 45 g of SiO_{0.5} powder (volume average particle size 3 μm), and 5 g of polytetrafluoroethylene in 50 ml of pure water. An oxygen removing layer with a thickness of 8 μm was formed in the same manner as Example 1, except that this slurry for an oxygen removing layer was used instead of the slurry for an oxygen removing layer of Example 1, and a positive electrode of the present invention was made. A lithium ion secondary battery of the present invention was made in the same manner as Example 1, except that this positive electrode was used.

### Comparative Example 1

A lithium ion secondary battery was made in the same manner as Example 1, except that SiO₂ (volume average particle size 5 μm), which is not an oxygen deficient non-stoichiometric oxide, was used instead of SiO_{0.5} powder (oxygen deficient non-stoichiometric oxide, volume average particle size 3 μm).

### Comparative Example 2

A lithium ion secondary battery was made in the same manner as Example 2, except that SiO₂ (volume average particle size 5 μm), which is not an oxygen deficient non-stoichiometric oxide, was used instead of SiO_{0.5} powder (oxygen deficient non-stoichiometric oxide, volume average particle size 3 μm).

### Comparative Example 3

A lithium ion secondary battery was made in the same manner as Example 3, except that SiO₂ (volume average particle size 5 μm), which is not an oxygen deficient non-stoichiometric oxide, was used instead of SiO_{0.5} powder (oxygen deficient non-stoichiometric oxide, volume average particle size 3 μm).

### Comparative Example 4

A lithium ion secondary battery was made in the same manner as Example 4, except that SiO₂ (volume average particle size 5 μm), which is not an oxygen deficient non-stoichiometric oxide, was used instead of SiO_{0.5} powder (oxygen deficient non-stoichiometric oxide, volume average particle size 3 μm).

### Experimental Example 1

The following evaluation test was carried out for the lithium ion secondary batteries obtained in Examples 1 to 5 and Comparative Examples 1 to 4.

### (Battery Capacity Evaluation)

A Charge and discharge cycle was repeated to a total of three times under the conditions shown below, and the discharge capacity at the third cycle was determined for the lithium ion secondary batteries obtained in Examples 1 to 5 and Comparative Examples 1 to 4. The results are shown in Table 1.

Constant Current Charge: 80 mA, end voltage 4.2 V.

Constant Voltage Charge: end current 40 mA, pause period 20 minutes.

Constant Current Discharge: electric current 80 mA, end voltage 2.5 V, pause period 20 minutes.

### (Nail Penetration Test)

The batteries after the capacity measurement were charged under the same conditions as that of the capacity measurement. An iron-made nail (diameter 2.7 mm) was penetrated through a battery with an open circuit voltage of 4.17 V under a 30° C. environment temperature bath at a speed of 5 mm/sec. The battery voltage at that time was monitored, and Table 1 shows the battery voltage and the highest battery surface temperature.

### (Heat Test)

The battery after the capacity measurement was charged under the same conditions as those of the capacity measurement, and the temperature was raised in a bath of 150° C. environment at a speed of 5° C./min. After reaching 150° C., the temperature was maintained for 3 hours. The battery voltage at that time was monitored, and Table 1 shows the battery voltage and the highest temperature at the battery surface after one second of the short circuit caused by the nail penetration in the battery. Under “Used in” of the “oxygen deficient non-stoichiometric oxide” column in Table 1, “oxygen removing layer” means that an oxygen removing layer was interposed between the positive electrode and the separator.

TABLE 1

| | | | | | | Nail Penetration | | |
|---|---|---|---|---|---|---|---|---|
| | | | | | | Test | | |
| | | | | | | Battery | | Heat Test |
| | | | | | | Voltage | Highest | Highest |
| | | | | | Battery | 1 sec | Battery | Battery |
| | | Oxygen Deficient | | | Capacity | after | Surface | Surface |
| | | Non-stoichiometric | | Negative | Discharge | Short | Temperature | Temperature |
| | | Oxide | | Electrode | Capacity | Circuit | Reached | Reached |
| | | Type | Used in | Composition | (mAh) | (V) | (° C.) | (° C.) |
| Ex. | 1 | SiO_{0.5} | Oxygen | Si | 430 | 4.12 | 31 | 151 |
| | | | Removing | | | | | |
| | | | Layer | | | | | |
| | 2 | SiO_{0.5} | Positive | Si | 428 | 4.05 | 34 | 152 |
| | | | Electrode | | | | | |
| | | | Active | | | | | |
| | | | Material | | | | | |
| | | | Layer | | | | | |
| | 3 | SiO_{0.5} | Oxygen | SiO_{0.5} | 430 | 4.14 | 31 | 151 |
| | | | Removing | | | | | |
| | | | Layer | | | | | |
| | 4 | SiO_{0.5} | Positive | SiO_{0.5} | 428 | 4.07 | 33 | 152 |
| | | | Electrode | | | | | |
| | | | Active | | | | | |
| | | | Material | | | | | |
| | | | Layer | | | | | |
| | 5 | SiO_{0.5} | Oxygen | Si | 429 | 4.12 | 31 | 151 |
| | | | Removing | | | | | |
| | | | Layer | | | | | |
| Comp. | 1 | (SiO₂) | Oxygen | Si | 428 | 4.00 | 35 | 156 |
| Ex. | | | Removing | | | | | |
| | | | Layer | | | | | |
| | 2 | (SiO₂) | Positive | Si | 427 | 3.90 | 37 | 157 |
| | | | Electrode | | | | | |
| | | | Active | | | | | |
| | | | Material | | | | | |
| | | | Layer | | | | | |
| | 3 | (SiO₂) | Oxygen | SiO_{0.5} | 428 | 4.02 | 35 | 156 |
| | | | Removing | | | | | |
| | | | Layer | | | | | |
| | 4 | (SiO₂) | Positive | SiO_{0.5} | 427 | 3.91 | 37 | 157 |
| | | | Electrode | | | | | |
| | | | Active | | | | | |
| | | | Material | | | | | |
| | | | Layer | | | | | |

Table 1 shows that in the lithium ion secondary batteries of the present invention, no decline in discharge capacity was observed but instead an improvement in discharge capacity was observed, though the improvement was of a small degree, due to the positive electrode containing the oxygen deficient non-stoichiometric oxide or the oxygen removing layer containing this oxide.

Additionally, when the battery voltages after one second of the short circuit are compared, the degree of voltage drop was small in the lithium ion secondary battery of the present invention. This shows that the energy (heat) released due to the short circuit smaller than in the lithium ion secondary batteries of Comparative Examples 1 and 2. That is, it can be assumed that oxygen generated in the positive electrode is absorbed by the oxygen deficient non-stoichiometric oxide, which decreased the oxidation reaction of the negative electrode. Accordingly, the increase in the battery temperature is also kept low. A similar tendency is observed in the heat test, and it can therefore ne assumed that the same effects are probably attained.

Furthermore, in Example 1, the oxygen removing layer containing the oxygen deficient non-stoichiometric oxide is provided on the surface of the positive electrode. In Example 2, the oxygen deficient non-stoichiometric oxide is contained in the positive electrode active material layer of the positive electrode. From the comparison between Example 1 and Example 2, it is clear that in Example 1 the voltage drop is even smaller, and the temperature increase at the battery surface is smaller in the nail penetration test. This is probably due to that fact that because the oxygen deficient non-stoichiometric oxide is present in the positive electrode surface, the spread of the short circuit is inhibited, and the voltage drop due to the heat generation by the short circuit can therefore be inhibited. That is, with the presence of the oxygen deficient non-stoichiometric oxide on the positive electrode surface, the spread of the short circuit is prevented.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion secondary battery comprising:
a negative electrode including an alloy-based negative electrode active material capable of absorbing and desorbing lithium; a positive electrode including a positive electrode active material capable of absorbing and desorbing lithium; a separator; and a non-aqueous electrolyte,
wherein the positive electrode includes an oxygen deficient non-stoichiometric oxide, or an oxygen removing layer containing an oxygen deficient non-stoichiometric oxide is provided between the positive electrode and the separator.

2. The lithium ion secondary battery in accordance with claim 1, wherein the alloy-based active material includes silicon or tin.

3. The lithium ion secondary battery in accordance with claim 1, wherein the alloy-based negative electrode active material is at least one selected from the group consisting of silicon, silicon oxide, silicon carbide, silicon nitride, a silicon-containing alloy, a silicon-containing compound, tin, tin oxide, tin nitride, a tin-containing alloy, and a tin-containing compound.

4. The lithium ion secondary battery in accordance with claim 1, wherein the positive electrode includes a positive electrode active material layer containing a positive electrode active material capable of absorbing and desorbing lithium and an oxygen deficient non-stoichiometric oxide, and a positive electrode current collector.

5. The lithium ion secondary battery in accordance with claim 1, wherein the positive electrode includes a positive electrode active material layer containing a positive electrode active material capable of absorbing and desorbing lithium, and a positive electrode current collector; and
an oxygen removing layer including an oxygen deficient non-stoichiometric oxide is provided so as to be brought into contact with the positive electrode active material layer.

6. The lithium ion secondary battery in accordance with claim 1, wherein the oxygen deficient non-stoichiometric oxide is an oxygen deficient non-stoichiometric metal oxide of at least one element selected from the group consisting of transition metal elements of the fourth to fifth periods of the periodic table; metal elements of the third period of the periodic table; and metalloid elements of the third to fifth period of the periodic table.

7. The lithium ion secondary battery in accordance with claim 1, wherein the oxygen deficient non-stoichiometric oxide is at least one selected from the group consisting of CUO₁₋ₐ, Cu₂O₁₋ₐ, Fe₂O₃₋ₐ, Fe₃O₄₋ₐ, FeO₁₋ₐ, SnO_{2-b}, ZnO₁₋ₐ, TiO₂₋ₐ, Ti₂O₃₋ₐ, TiO₁₋ₐ, V₂O_{5-c}, VO₁₋ₐ, VO₂₋ₐ, MoO_{2-b}, MoO₃₋ₐ, MnO₁₋ₐ, MnO_{2-b}, Mn₂O₃₋ₐ, SiO₂₋ₓ, MgO_{1-y}, and Al₂O_{3-z} (where 0<a≦0.8, 0<b≦1.8, 0<c≦2.8, 0<x<2, 0≦y<1, and ≦z≦3).

8. The lithium ion secondary battery in accordance with claim 1, wherein the oxygen deficient non-stoichiometric oxide is at least one selected from the group consisting of SiO₂₋ₓ, MgO_{1-y}, and Al₂O_{3-z} (where 0<x<2, 0<y≦1, and 0<z<3).
